(19) United States
(12) Patent Application Publication
(10) Pub. No.: US 2021/0138921 A1
(43) Pub. Date: May 13, 2021

(54) MODULAR CHARGING STATION FOR URBAN MICRO-MOBILITY VEHICLES

(71) Applicant: Get Charged, Inc. dba Charge, New York, NY (US)

(72) Inventors: Andrew Fox, New York, NY (US); Dan Waldman, Englewood Cliffs, NJ (US); Mark Lojek, Livingston Manor, NY (US)

(21) Appl. No.: 17/092,643

(22) Filed: Nov. 9, 2020

Related U.S. Application Data
(60) Provisional application No. 62/932,612, filed on Nov. 8, 2019.

(51) Int. Cl. B60L 53/30; H02J 7/00; B60L 53/18; B60L 53/62; B60L 53/68; B60L 53/66

(52) U.S. Cl. CPC B60L 53/30; H02J 7/0013; H02J 7/0048; H02J 7/0045; H02J 2207/40; B60L 53/62; B60L 53/68; B60L 53/665; B60L 53/18

(57) ABSTRACT

A charging station for charging micro-mobility (MM) vehicles, including: a primary docking module having a first plurality of charging stalls, each stall configured to store and charge an MM vehicle; a secondary docking module having a second plurality of charging stalls, each stall configured to store and charge an MM vehicle; and a power distribution module (PDM) and command and control module (CCM) embedded in the primary docking module, wherein the PDM and CDM are configured to distribute and control power to both the first plurality of charging stalls and second plurality of charging stalls. An associated charging infrastructure provides a MM agnostic platform while also having the ability to serve private subscriber based users.

### TECHNICAL FIELD

The subject matter of this invention relates to a charging station for urban micro-mobility (MM) vehicles, including electric scooters, electric bikes, etc.

### BACKGROUND

Micro-mobility (MM) rechargeable vehicles, e.g., scooters, bikes, etc., (“MM vehicles”) have become extremely popular in urban settings. Current MM providers such as BIRD, LIME, etc., rely on dedicated company or independent field teams (referred to as “juicer” or “chargers”) to recharge scooters, often in their own home at night. Chargers for example pick up scooters left on the streets, bring them to their home for charging overnight, and return them to designated locations in the morning. Chargers receive a monetary reward for their efforts. Each MM provider generally utilizes a proprietary dispatch service and downloadable smartphone application (app) that tracks and broadcasts provider-based vehicle information.

Unfortunately, charging is subject to significant chaos and the current approach is both unsustainable and unsafe.

### SUMMARY

Aspects of the disclosure describes a charging infrastructure having provider agnostic charging stations, i.e., the infrastructure is set up to charge MM vehicles deployed by disparate MM providers. Described charging stations include a power distribution system that can utilizes either an AC or DC power supply and are modular, allowing stations to be easily expanded.

A first aspect provides a charging station for charging micro-mobility (MM) vehicles, comprising: a primary docking module having a first plurality of charging stalls, each stall configured to store and charge an MM vehicle; a secondary docking module having a second plurality of charging stalls, each stall configured to store and charge an MM vehicle; and a power distribution module (PDM) and command and control module (CCM) embedded in the primary docking module, wherein the PDM and CDM are configured to distribute and control power to both the first plurality of charging stalls and second plurality of charging stalls.

A second aspect provides an agnostic micro-mobility (MM) charging infrastructure for charging MM vehicles, comprising: a plurality of charging stations, wherein each charging station includes: a set of charging stalls configured to store and charge MM vehicles deployed by disparate MM providers, and a command and control module (CCM) that can activate and deactivate power to each charging stall and collect power usage data from each stall, wherein the CCM further includes a communication system that can receive activation instructions and transmit usage data; and a remote management system, comprising: a communication interface for communicating with each CCM in the charging stations; a third party integration API service that allows different MM apps provided by the disparate MM providers to obtain information associated with the plurality of charging stations, and request and be granted charging access at a selected charging station for an MM vehicle; and an accounting system that allocates usage costs to each of the disparate MM providers.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a perspective view of a charging station for micro-mobility rechargeable vehicles including twelve charging slots according to embodiments.

FIG. 2 shows an exploded view of the charging station according to embodiments.

FIG. 3 depicts a top view of a charging station according to embodiments.

FIG. 4 depicts a perspective view of a DC powered charging station according to embodiments.

FIG. 5 depicts a perspective view of a DC powered charging station holding scooters according to embodiments.

FIG. 6 shows a perspective view of an alternative charging station for micro-mobility rechargeable vehicles according to embodiments.

FIG. 7 depicts the alternative charging station with its top open according to embodiments.

FIG. 8 depicts a power distribution and control system according to embodiments.

FIG. 9 depicts a command and control module according to embodiments.

FIG. 10 depicts a remote management system according to embodiments.

FIGS. 11a, 11b and 11c depict app interfaces according to embodiments.

FIG. 12 depicts a remote management system interface according to embodiments.

FIG. 13 depicts a remote management system interface according to embodiments.

FIG. 14 depicts a battery tower according to embodiments.

FIG. 15 depicts a charging station having a solar canopy according to embodiments.

FIG. 16 depicts a computing system according to embodiments.

The drawings are not necessarily to scale. The drawings are merely schematic representations and are not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

A charging infrastructure is described having provider agnostic charging stations, i.e., the infrastructure is set up to charge MM vehicles deployed by disparate MM providers. In the current state of the art, each MM provider utilizes a proprietary app and related infrastructure for charging their own deployed MM vehicles. Accordingly, in order to charge a BIRD scooter, the user must utilize the BIRD app. Further, because charging cables for different MM providers are not necessarily the same, charging stations are typically only equipped to charge MM vehicles from a specific provider. The present infrastructure provides agnostic charging stations that can charge MM vehicles from disparate providers. Additionally, modularly designed charging stations are provided that can be easily moved and expanded, and which include a power distribution system that can utilizes either an AC or DC power supply.

Referring now to the drawings, FIG. 1 depicts a perspective view of an illustrative modular docking module 10 for charging micro-mobility vehicles. In this example, module 10 is configured to store and charge six rechargeable scooters. However, it is understood module 10 could be configured for other types of vehicles, e.g., electric bikes, etc. As detailed herein, module 10 can be easily mated with other modular components as needed to create an expanded charging station, which can be easily delivered and setup at locations as demand requires. As further explained herein, module 10 can be powered either by an AC or DC power source. In the case of AC, module 10 can be equipped with a standard plug 30, powered with a 30 A (amp), 120V or 20 A (amp) 240V (volt) service. In the case of DC, module 10 is connected to a battery housing unit capable of providing, e.g., a 2 A, 42 or 54V service, as described in further detail below.

In the example shown in FIG. 1, module 10 has six charging stalls configured to power six scooters, three on the front and three on the back. It is understood however that the size and configuration of module 10 may vary. Regardless, module 10 generally includes a top platform 20, posts 22, and a bottom platform 25. (Note that the actual charging cables that connect to individual vehicles are not shown in this view.)

FIG. 2 depicts an exploded view of docking module 10. In this illustrative embodiment, the bottom platform 25 includes a paver plate 32, a pair of sub-frame rails 34 and wheel hubs 24. The top platform 20 includes a main dock body 38, access panels 35 that provides access to electrical componentry (not shown) from below the top platform 20, a dock end cap plate 37, a dock end section plate 39, post covers 33, and guide supports 26. In one embodiment, all of the components are fabricated from steel, with the exception of the wheel hubs 24, post covers 33, and guide supports 26, which are fabrication thermoformed plastic. However, it is understood that components may be fabricated from any material. In this depicted embodiment, paver plate 32 has a slightly wider cross-section than the top platform 20, and includes a beveled edge, allowing scooters to be easily rolled up and placed in the wheel hubs 24.

FIG. 3 depicts a top view of a further embodiment in which a secondary docking module 12 is connected to docking module 10 (i.e., the primary docking module) to create a docking station having twelve charging stalls. Each charging stall includes a universal charging cable 28 capable of charging scooters from different providers (e.g., BIRD, LIME, etc.) as well as a visual display (e.g., an LED) for providing charging information to a user. Primary and secondary docking modules 10, 12 are largely identical with the exception of a power distribution module (PDM) 44 and command and control module (CCM) 46 that are incorporated in the top platform 20 of the primary docking module 10. As described in further detail herein, the PDM 44 and CCM 46 are responsible for controlling, tracking, and distributing power to each charging stall in both the primary and secondary docking modules 10, 12. Modules 10, 12 can be connected to each other in any manner, e.g., clamps, nuts and bolts, etc.

FIG. 4 depicts a DC charging station 11 that is further equipped with a battery housing unit 14 configured to store a set of batteries that provide DC power to the station 11. In one embodiment, lithium ion batteries or the like are stored in the housing unit 14, which can be swapped out or recharged in situ as needed. In the depicted DC embodiment, the modular components generally include the battery housing unit 14, a primary docking module 10, and one or more secondary docking modules 12.

As noted, both the primary and secondary docking modules 10, 12 generally include a bottom platform 25, posts 22, and a top platform 20. The bottom platforms 25 include hubs 24 for receiving a front wheel of a scooter, and the top platforms 20 include guide supports 26 for receiving a scooter handlebar stem. Each of a set of charging stalls are formed by a vertically corresponding hub 24 and guide support 26. Each charging stall also includes a universal charging cable 28 that connects to a scooter parked in an associated stall to charge a scooter parked therein. The universal charging cable may for example include a single wire with multiple different plugs, or multiple wires each with a different plug. Each charging stall further includes a visual indicator 27, such as an LED readout, LCD screen, etc., that provides information such as a charge stall availability, charging level, etc.

In this embodiment, each docking module 10, 12 includes six charging stalls (three on each side). However, it is understood that docking modules 10, 12 may include greater or fewer than six charging stalls. In this DC embodiment, primary docking module 10 is connected to battery housing unit 14 on one end and to secondary docking module 12 on the other end. Additional secondary docking modules (not shown) could also be connected to the depicted secondary docking module 12 on its far end. FIG. 5 depicts a top perspective view of the charging station 11 holding scooters 30, each in unique charging stall.

FIG. 6 depicts an alternative configuration of a charging station 50 that includes two “one-sided” docking modules 52, 54, implemented for an AC supply using plug 56. Charging station 50 includes twelve total charging stalls 58, with all the stalls 58 being on the front side of the station 50. (Note that universal charging cables and visual displays are not depicted for ease of viewing, but would be associated with each stall 58 as described above.) The depicted configuration could alternatively be implemented for a DC supply with the addition of a battery housing unit 14 (as described above). As with the previous embodiments, docking modules 52, 54 are essentially identical, with the exception that module 52 includes a PDM 44 and CCM 46 (not shown) for distributing, tracking and controlling the power to each stall in both modules 52, 54.

In order to provide easy access to electrical components contained therein, the top panel 60 on each module 52, 54 is hinged (similar to a piano hinge) to fold towards the front (as indicated by the arrows), revealing the interior of the respective top platform. An example of this is shown in FIG. 7, in which top panels 60 are folded towards the front, exposing the interior of each top platform. Each top platform contains wiring, etc., that feeds a respective universal charging cable 28 (only one cable shown for ease of viewing). In addition, the interior of the top platform includes a back rail 62 that is configured to hold a respective DC driver 64 proximate each charging stall. Accordingly, in the event a DC driver, visual display, or associated wiring needs to be repaired or replaced, a maintenance person need only swing open the top panel for access.

FIG. 8 depicts a power distribution and control system for a charging station, such as station 50 of FIGS. 5 and 6 (or alternatively stations 10 or 11 described above) having two docking modules 52, 54. As noted, primary docking module 52 includes a power distribution module (PDM) 42 and command and control module (CCM) 44, that handle the power distribution and control for each individual charging stall in both modules 52, 54. It is noted that the same power distribution and control system shown can be used for either an AC or DC power supply 46. In this example, PDM 42 receives power from an AC supply 46, e.g., a conventional 30 A 120/240V receptacle, and distributes AC power to a set of DC drivers 64 via PDM outputs 48. Outputs 48 on PDM 42 may include a set of harness connections, in which each harness connection is configured to power a selected docking module 50, 52, e.g., via a six channel harness that plugs into the PDM 42. Accordingly, when a new docking module is added or removed, a corresponding harness is simply plugged into or removed from the PDM 42.

Each DC driver 64 is configured to receive either AC or DC and output a conditioned DC supply, suitable for charging a scooter or the like via a universal charging cable 28. In one illustrative embodiment, the DC drivers 64 may include Mean Well® HGL 185 series drivers, which are capable of receiving 90-264V AC, or 127-370V DC. The output can for example provide 42V DC, which supports the common scooter charge requirements of 2 A at 42 VDC. As scooters evolve, the drivers can upgraded or adjusted, e.g., up to 4.4 A, to handle different requirements. Power distribution and control system may include smart power throttling to optimize battery charging times and power retention before, during and after use.

Each driver 64 is located proximate a corresponding charging stall 58 on the station 50, and receives power from the PDM 42 located in module 52 via lines 66. The conditioned DC output of each driver 64 (in this case, six per module), is forwarded to CCM 44 via lines 68. CCM 44 includes a set of controllable relays that can activate or deactivate the flow of current back to each individual charging stall 58 along lines 70. Accordingly, when a user wants to have a scooter charged by station 50, the user can interface with a remote management system, e.g., via a smart device, to obtain access and cause CCM 44 to activate one of the charging stalls 58. CCM 44 also manages and controls the visual displays 24 at each charging stall 58, e.g., indicating stall availability, charge levels, etc.

FIG. 9 depicts a block diagram of an illustrative CCM 44 which includes a processing unit 82, I/O 86, and embedded functionality (e.g., software, firmware or hardware) managed by the processing unit 82. Embedded functionality, e.g., includes: a communication system 72, e.g., a GSM modem, that connects wirelessly to the remote management system 82 to receive/transmit instructions and other data; a charge stall activation system 74, e.g., employing relays, that can active and deactivate charging stalls based on instructions received via communication system 72 and/or the presence/absence of a plugged in scooter; a usage monitor 76 that monitors the current/voltage usage (e.g., for billing purposes, for determining MM charge levels, for determining when a scooter is present/absent, etc.) at each charging stall; a display manager 78 that controls the visual display output (e.g., LED color) for each charging stall; and a data processor 80 that collects and processes data associated with CCM 44. CCM may be implemented with, e.g., a Raspberry Pi device. CCM 44 accordingly provides a vertically integrated hardware, networking, and software suite that enables remote real-time monitoring/operations/fault detection, detailed power metering/billing, and interoperability with third-party micro-mobility vehicle partners.

During operation, the output of each of the DC drivers are brought to the CCM 44, which are monitored for voltage and current and controlled (ON/OFF) by processing unit 84. The relay is in the off position until the processing unit 84 validates a request to charge a stall, e.g., from an end user's mobile application. A signal is sent from the processing unit to energize or switch the relay to the ON position. Once the scooter is disconnected, the lack of a signal will indicate to the CCM 44 to close the relay. This information is logged and is available on an individual charge session basis—complete information as to the micro-mobility service provider and scooter ID. The information can be used for both usage reports and billing/invoicing purposes.

FIG. 10 depicts an illustrative overview of a remote management system 82 that manages a set of charging stations 92 (such as those described herein) for: (1) users 90; (2) MM provides such as BIRD, LIME, etc., also referred to as partners; and (3) fleet operators, e.g., charging station owners, operators, etc. Remote management system 82 can communicate with CCMs on each station 92 via communication interface 95 (e.g., a wireless modem that makes use of a public Internet over a virtual private network (VPN)). As noted, the described system 82 and charging stations 92 are MM provider agnostic in that they allow for charging of vehicles deployed by different MM providers, as well as privately owned vehicles. Users 90 of a particular MM provider vehicle simply utilize the micro-mobility app 91 of the MM provider to locate and activate charging stalls on a station 92. To achieve this, remote management system 82 includes a third party integration API service 94 that allows MM providers to have their proprietary apps 91 interface with the remote management system 82 to view and access charging station information and activate charging stalls for users 90.

Third party integration API service 94 allows users of MM apps 91 to search for charging stations by geographical area, obtain real-time information about charging stalls, and perform a hand-off process. The hand-off process includes a procedure where a charging stall gets activated, a vehicle is plugged in, and the resulting charging session is linked with the MM provider (i.e. partner) for billing purposes. Charging stalls are disabled as soon as a vehicle is fully charged or is unplugged, guaranteeing proper attribution of costs and preventing unauthorized use. Accordingly, third party integration API service allows MM apps 91 provided by the disparate MM providers to obtain information (e.g., location, availability, etc.) associated with a set of charging stations 92, and request and be granted charging access at a selected charging station for an MM vehicle.

Remote management system 82 further includes a fleet management API service 96 that allows owners or operators of one or more stations 92 to manage their fleet, e.g., view operational and usage data, etc. Also included is an internal API service 98 that including an accounting system 97 to, e.g., track usage, billing and analytic information for disparate MM providers and fleet operators. For example, when a user of BIRD uses one of the charging stalls at a charging station 92 to charge a BIRD scooter, the usage and cost is calculated and billed directly to BIRD by the internal API service 98. Similarly, use of a different charging stall at the same station 92 by a LIME scooter would result in a bill to LIME.

In one embodiment, when a user 90 of a MM vehicle requires a charge, the user can access a charging station either via remote management system 82 using a provider's MM app 91. Such apps 91 include functionality to identify a specific vehicle including make, model, and identification number, which can be provided to system 82. System 82 can then grant charging access to the specific vehicle at an assigned charging stall. Because each station is equipped to charge MM vehicles from different providers, a universal charging cable 28 is provided that may include different types of connectors. When a universal charging cable 28 is connected to a MM vehicle, system 82 can also determine if the vehicle being plugged in is the correct vehicle. Identification of the vehicle may be done, for example, by scanning a QR code, using image recognition, using IoT device communication, etc. Charging stations 92 may also include a capability to sell charges and seek payment from private users. Payment and invoicing may include conventional payment and invoicing methods such as credit cards and emails and may include digital methods of point-of-sale invoicing and payment.

FIGS. 11a,b,c depict illustrative interfaces provided by an MM app 91, that can access remote management system 82 via the API 94. FIG. 11a shows a map view that for example depicts the location of stations 92 near the user. FIG. 11b provides an interface that allows the user to scan a QR code on a scooter when at a selected charging station 92. FIG. 11c indicates a highlighted location or stall (in this case, 01) for the user to charge the scooter.

FIG. 12 depicts an illustrative interface provided by remote management system 82 that can be used by a fleet operator to view the performance of their fleet of charging stations 92. In this case, a graph is depicted that shows the number of sessions started at different times of the day. For example, at 5 am, 9 sessions were started. Also shown is the average energy used per session (265.09 Wh) and average duration of a session (2 h 34 m).

FIG. 13 depicts an interface provided by remote management system 82 that shows details of a selected station. In this case, the interface shows which stalls are available at a station, and which are currently charging.

Remote management system 82 may provide any number of additional interfaces, including detailed utilization and charging metrics for each stall and each charging stall in the fleet; the ability to drill down to specific periods of time, view information of specific fleet operators, and access data-driven insights (e.g., most popular stalls, time-of-day distribution, average charging session metrics, etc.); stall specific data including station maps, the ability to drill down and access the real-time operational status of each station, diagnostic data, current sensor readings, charging history, etc.; provider (i.e., partner) interfaces that provide the ability to onboard and invoice micro-mobility partners who take advantage of the provided charging infrastructure; and operational data that may include an up-to-date overview of anything requiring attention within a fleet.

Additionally, a web dashboard can be provided for partners, where they can access detailed utilization metrics, their API access credentials, and receive invoices for the services provided. Further, various contractor tools may be deployed, including a mobile application that can be used to drop off vehicles at stations for charging, for example in the context of a rebalancing operation. The tool can either be used in unrestricted fashion by the fleet operator, or alternatively by micro-mobility partners who need to charge their own vehicles.

As noted, in some embodiments, charging stations 92 may be powered by DC, e.g., using lithium ion batteries or any other type of rechargeable battery. The number and size of lithium ion batteries may vary. Batteries may be swapped out at DC powered stations as required (e.g., every few days) or be recharged at the station 92, e.g., by portable electric devices, for example, cars, drones, etc., by connecting to a battery harness. For example, a recharging vehicle such as an electric car (e.g., a Tesla) or the like may park near the charging station, connect a cable from the electric car's power terminal to the charging station batteries via a harness, and use the electric car's battery to recharge the station 92. The operator of the electric vehicle may for example be compensated in exchange for the service.

FIG. 14 depicts an illustrative example of a DC energy module tower 100 adapted to fit into housing 14 (FIGS. 4 and 5). The tower 100 includes a set of slide-in shelves 104 that each receive a battery module 102. Each module 102 may for example provide 14.8 V DC. Each module 102 may comprise two slivers, each of which may comprise two lithium ion cells. In this example, the tower 100 is configured to hold nine modules 102 to provide 133V DC. A battery management system (BMS) 106 is located on the outside of the tower 100.

In one embodiment, each module is wired to an adjacent module in series, and positive and negative terminal wires are fed to the power distribution module 42 (FIG. 8). In another embodiment, modules 102 can be configured to plug into physical plug-and-play type interfaces, e.g., having power bars that form the electrical connections in the tower 100 without wires.

Batteries may also be charged by other sources such as solar panels affixed to or separate from the charging station. FIG. 15 depicts an illustrative charging station having a solar panel canopy 104, which could generation 12V DC, and recharge batteries in the housing. Charging stations may include an awning to direct rain away, and the awning may be equipped with photovoltaic panels. Charging stations may include solar panel mounting brackets securing photovoltaic panels and may provide capability that optimizes a sun facing angle, for example, an approximately 15-25 degree tip towards the south in the northern hemisphere. Solar systems may include low quiescent current DC-DC converter systems for maximum efficiency solar energy MPPT function to maximize usefulness available solar panel output.

Further, charging stations 92 may include wireless charging capability for charging vehicles. Wireless charging capability may be configured through, for example, a floor of charging station or a collar holding the vehicle.

Charging stations 92 may include devices to physically secure vehicles to the charging station, such a controllable lock/steel bar arrangement. Charging stations 92 may include surveillance systems for security purposes both in protecting the charging station from vandalism, theft, and other threats and in protecting users of the charging station 10

Stations may include diagnostics through, for example, heat-sensing and machine learning cameras detecting battery status and damage and may include detection of structural vehicle damage and enable automatic reporting to stakeholders, for example, users, operators, municipalities, insurance companies, and so forth. Wireless communication may be implemented in any manner, including WiFi, built-in 5G signal booster hubs, a smart network that allows inter-station, inter-vehicle and inter-phone connectivity and analytics.

Charging stations may also include a system of bracket plates and fasteners to enable concrete or asphalt surface anchoring system.

FIG. 16 depicts a block diagram of a computing device 110 useful for practicing an embodiment of remote management system and/or CCM. The computing device 110 includes one or more processors 103, volatile memory 122 (e.g., random access memory (RAM)), non-volatile memory 128, user interface (UI) 123, one or more communications interfaces 118, and a communications bus 150.

The non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

The non-volatile memory 128 stores an operating system 115, one or more applications 116, and data 117 such that, for example, computer instructions of the operating system 115 and/or the applications 116 are executed by processor(s) 103 out of the volatile memory 122. In some embodiments, the volatile memory 122 may include one or more types of RAM and/or a cache memory that may offer a faster response time than a main memory. Data may be entered using an input device of the GUI 124 or received from the I/O device(s) 126. Various elements of the computer 110 may communicate via the communications bus 150.

The illustrated computing device 110 is shown merely as an example client device or server, and may be implemented by any computing or processing environment with any type of machine or set of machines that may have suitable hardware and/or software capable of operating as described herein.

The processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

In some embodiments, the processor 103 may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

The communications interfaces 118 may include one or more interfaces to enable the computing device 100 to access a computer network such as a Local Area Network (LAN), a Wide Area Network (WAN), a Personal Area Network (PAN), or the Internet through a variety of wired and/or wireless connections, including cellular connections.

In described embodiments, the computing device 110 may execute an application on behalf of a user of a client device. For example, the computing device 110 may execute on one or more virtual machines managed by a hypervisor. Each virtual machine may provide an execution session within which applications execute on behalf of a user or a client device, such as a hosted desktop session. The computing device 110 may also execute a terminal services session to provide a hosted desktop environment. The computing device 110 may provide access to a remote computing environment including one or more applications, one or more desktop applications, and one or more desktop sessions in which one or more applications may execute.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A charging station for charging micro-mobility (MM) vehicles, comprising:
a primary docking module having a first plurality of charging stalls, each stall configured to store and charge an MM vehicle;
a secondary docking module having a second plurality of charging stalls, each stall configured to store and charge an MM vehicle; and
a power distribution module (PDM) and command and control module (CCM) embedded in the primary docking module, wherein the PDM and CDM are configured to distribute and control power to both the first plurality of charging stalls and second plurality of charging stalls.

2. The charging station of claim 1, wherein each docking module includes a set of DC drivers configured to output a DC charging output, wherein each DC driver is associated with and located proximate a respective charging stall, and wherein the PDM includes a first distribution output that couples to the DC drivers in the primary docking module and a second distribution outlet that couples to the DC drivers in the secondary docking module.

3. The charging station of claim 2, wherein the PDM is equipped to distribute both AC and DC power and DC drivers are equipped to receive both AC and DC power.

4. The charging station of claim 3, wherein an output of each DC driver is coupled to a relay in the CCM, and the output of each relay is coupled to a charging cable at a respective charging stall.

5. The charging station of claim 4, wherein the CCM activates and deactivates a selected relay in response to wireless signals received from a remote management system indicating that a corresponding charging stall is permitted to charge an identified MM vehicle.

6. The charging station of claim 5, wherein the CCM tracks power usage of the corresponding charging stall for charging the identified MM vehicle.

7. The charging station of claim 5, wherein each charging stall includes a visual display that indicates a status of an associated charging stall, wherein each visual display is controlled by the CCM.

8. The charging station of claim 7, wherein the status includes at least of:
availability of the associated charging stall and a charge level of the MM vehicle.

9. The charging station of claim 7, wherein the CCM includes a system for reporting usage of each charging stall to the remote management system.

10. The charging station of claim 7, wherein the charging cable comprises a universal charging cable configured to fit and charge different types of MM vehicles owned by different MM vehicle providers.

11. The charging station of claim 7, wherein both the primary and secondary docking modules include a bottom platform, at least one post, and a top platform, wherein the top platform includes a hinge that allows a top panel of the top platform to open and reveal an interior space.

12. The charging station of claim 11, wherein the interior space includes a rail on to which each of the set of DC drivers are mounted.

13. The charging station of claim 3, further comprising a battery housing unit coupled to the primary docking module, wherein the battery housing unit houses a rechargeable battery system.

14. The charging station of claim 13, wherein the rechargeable battery system includes a tower having a set of shelves for receives a set of battery modules.

15. The charging station of claim 14, wherein the set of battery modules are connected in series and include a positive and negative terminal that connect to the PDM.

16. An agnostic micro-mobility (MM) charging infrastructure for charging micro-mobility (MM) vehicles, comprising:
a plurality of charging stations, wherein each charging station includes:
a set of charging stalls configured to store and charge MM vehicles deployed by disparate MM providers, and
a command and control module (CCM) that can activate and deactivate power to each charging stall and collect power usage data from each stall, wherein the CCM further includes a communication system that can receive activation instructions and transmit usage data; and
a remote management system, comprising:
a communication interface for communicating with each CCM in the charging stations;
a third party integration API service that allows MM apps provided by the disparate MM providers to obtain information associated with the plurality of charging stations, and request and be granted charging access at a selected charging station for an MM vehicle; and
an accounting system that allocates usage costs to each of the disparate MM providers.

17. The charging infrastructure of claim 16, wherein each CCM includes a set of relays for activating and deactivating each stall.

18. The charging infrastructure of claim 16, wherein each CCM includes a display manager that controls a visual display at each stall, wherein the visual display includes at least of: availability of an associated charging stall and a charge level of the MM vehicle at the associated charging stall.

19. The charging infrastructure of claim 16, wherein the remote management system includes a set of web interfaces that allow each of the disparate MM providers to view charging information associated with MM provider vehicles.

20. The charging infrastructure of claim 16, wherein each charging stall includes a universal charging cable configured to connect to MM vehicles deployed by the disparate MM providers.
